(19) United States
(12) Patent Application Publication
(10) Pub. No.: US 2026/0133541 A1
(43) Pub. Date: May 14, 2026

(54) MAGNETIC CONTROL AND/OR DRIVE MECHANISM THROUGH A WATCHCASE

(71) Applicant: The Swatch Group Research and Development Ltd, Marin (CH)

(72) Inventor: Jean-Jacques BORN, Morges (CH)

(73) Assignee: The Swatch Group Research and Development Ltd, Marin (CH)

(21) Appl. No.: 19/347,842

(22) Filed: Oct. 2, 2025

(30) Foreign Application Priority Data
Nov. 14, 2024 (EP) 24213053.2

(51) Int. Cl. G04C 9/08; G04C 1/02

(52) U.S. Cl. CPC G04C 9/08; G04C 1/02

(57) ABSTRACT

A watch assembly (2000) including a watch (1000), and a setting tool (200) driving an external drive mobile (20) so as to pivot around an external axis (DE) including an external multipolar magnet (21) engaging, to carry out a setting, with an internal multipolar magnet included by an internal control mobile (1) of the watch (1000) pivoting around a first axis (D1) and meshing with the entry of a reduction train (30) in which the exit meshes with an internal controlled mobile pivoting in the case (10), this setting tool (200) including means for counting the number of turns of the drive mobile (20) to precisely determine the pivot angle of the internal controlled mobile and/or means for determining and/or visualising the angular position of the internal controlled mobile.

### CROSS REFERENCE TO RELATED APPLICATIONS

This application claims priority to European Patent Application No. 24213053.2, filed on Nov. 14, 2024, the entire contents of which are incorporated herein by reference.

### TECHNICAL FIELD OF THE INVENTION

The invention relates to a horology assembly comprising at least one watch, and an adjustment tool, for driving, with no direct contact, a mobile inside the watch through its case, for the purpose of setting and/or recharging energy.

The invention also relates to a method for using such a horology assembly.

The invention also relates to a watch for the horology assembly of the invention.

The invention relates to the field of setting and/or drive control mechanisms for timepieces.

### TECHNOLOGICAL BACKGROUND

There are many mechanical systems for setting the functions of a wristwatch through the casing, such as buttons, crowns, and the like. However, all mechanical elements that run through the casing must be water-resistant, through the use of O-rings or other joints, for example, with the problems that this entails.

Moreover, certain movement settings, such as the rate, are better adjusted once the watch is closed, as the casing operation often causes a difference between the fitting on the movement and the assembled watch.

For these two particular reasons, it is desirable to have a magnetic coupling for rotating an internal component of the watch with an external tool.

Document EP4124584 describes a magnetic coupling that can transmit high couple inside a watchcase. However, the two counteracting magnetic parts must be close to each other, which rules out automatic watches and thick backs.

Document EP3579061 describes a device for correcting the state of a quartz watch. A magnet rotating beneath the watch directly drives the motor rotor in one direction or the other, depending on the correction required.

### SUMMARY OF THE INVENTION

The invention proposes to use means for transmitting a couple or a force through a watch casing using a magnetic coupler, so as to perform a mechanical setting, for example a rate setting or a state setting, or to wind the watch or perform other operations once the watch is assembled (movement cased).

The proposal consists of placing a small bipolar Lavet motor rotor magnet in the watch movement, and putting a high-ratio gear train between this magnet and the object that has to be rotated to obtain the necessary couple. The rotor can then be driven with an external bipolar magnet from a relatively great distance, compatible with any type of watch, in particular an automatic watch or a watch with a thick back.

To this end, the invention relates to a horology assembly according to claim 1.

The invention also relates to a method for using such a horology assembly, enabling mechanical slack to be compensated before proceeding with the actual micrometric setting.

The invention also relates to a watch as defined by claims 22 to 34.

### BRIEF DESCRIPTION OF THE FIGURES

The purposes, advantages and characteristics will be better understood on reading the following detailed description, with reference to the accompanying figures, in which:

FIGS. 1 to 5 illustrate a horology assembly according to the invention, comprising a timepiece, in particular a watch, and an external setting tool, comprising drive means and arranged to drive a mobile inside the watch;

FIG. 1 shows a schematic, partial cross-section of such a horology assembly comprising a watch, along a first axis of rotation around which, between an upper bar and a plate, is a rotationally mobile control mobile inside the watch, which carries a control pinion engaging with the entry of a reduction train comprising wheels stepped around two transfer axes; this internal control mobile carries an internal multipolar magnet, in particular a bipolar magnet, similar to a Lavet motor rotor magnet in the non-limitative application illustrated; this horology assembly also comprises a setting tool, comprising a drive mobile external to the watch, rotationally mobile around an external axis, and which carries another external multipolar magnet, in particular a bipolar magnet;

FIG. 2 shows a close-up of FIG. 1, in cross-section along the axis of rotation of the internal control mobile and via the two transfer axes of the

reduction train, and showing this internal control mobile, pivoted between two plates or bars, and carrying a control pinion that meshes with an entry mobile of the reduction train, in this case the latter comprising, but not limited to, five gears; this compact version of the reduction train comprises, around two separate transfer axes, two superimposed sets of stepped wheels each with the same diameter, this reduction train comprising an exit mobile intended to mesh with an internal controlled mobile;

FIG. 3 shows another close-up of the same watch, shown schematically, partially and in cross-section, along a second axis of rotation around which is a rotationally mobile controlled mobile, and via the two transfer axes of the reduction train: the controlled mobile also pivots between the upper bar and the plate, and carries a wheel engaging with the exit mobile of the reduction train;

FIG. 4 shows a schematic top view of the engagement of the internal control mobile, of the reduction train, in this case non-limitatively arranged around two transfer axes, and of the controlled mobile, in this case a snail cam; in this particular and non-limiting arrangement, in which the reduction train comprises stepped wheels with the same diameter, the exit mobile of the reduction train conceals in this figure the entry mobile, which is identical to it when projected in a plane; the upper bar carries a scale with respect to which the angular position of an index carried by the controlled mobile can be located;

FIG. 5 shows the same assembly, with the internal control mobile in a different position and the controlled mobile in a new position;

FIG. 6 shows the assembly in the position in FIG. 4, seen in the direction of arrow A, according to a cross-section along the axes of rotation of the internal control mobile and of the controlled mobile;

FIG. 7 shows a schematic representation, in plan view and in cross-section along its first axis of rotation, of the internal control mobile, in a simplified embodiment in which its internal multipolar magnet is bipolar;

FIG. 8 is a block diagram showing a horology assembly according to the invention, comprising a setting tool capable of engaging with different watches in this assembly that have the same internal control mobile and the same interface with this setting tool.

### DETAILED DESCRIPTION OF THE INVENTION

Patent EP3252545 describes a magnetic coupling system between the inside and outside of the casing that enables the winding stem to be coupled to a rate-setting system by changing the inertia of a special balance. In particular, an encrypted external magnetic key with permanent magnets turns an internal ring with ferromagnetic targets by means of magnetomechanical coupling. The ring is rotationally locked, either by elastic axial maintenance against a brake lever, or by a blocking device secured to the axial movement of the arbor, thus ensuring that its hold against rotational shocks.

This highly effective system essentially acts as a relay for the rotational couple on the arbor, which is the sole guarantor of the internal mechanical function, in this case the change in inertia of the special balance. It is therefore not suitable, on its own, for providing the couple required for the setting in question, or for energy recharging. The magnetic feedthrough system has to engage with another energy supply system, which also has to be suitable for the magnetic relay. This all makes for a relatively complex assembly.

The invention provides a system related to the one described in patent EP3252545, but which is not dependent on any button or on the arbor, and is therefore capable of producing a direct couple/force, this new system also being encrypted and having its own mechanical locking/disengagement function as well as being easier to operate. The encryption of the invention is linked to the relative spatial position of the setting tool relative to the internal control mobile, radially and axially, and the correlation between the number of turns imparted to a drive mobile external to the watch, comprised in a setting tool, and the rotation imparted to a controlled mobile inside the watch, via a control mobile inside the watch, magnetically engaging with this external drive mobile, and via a reduction train with a high reduction ratio.

The invention consists of placing a small magnet, in particular a bipolar one such as a Lavet motor rotor magnet, in the watch movement, and putting a high-ratio gear train between this magnet and the object that has to be rotated to obtain the necessary couple. The rotor can be driven by an external magnet, in particular a bipolar magnet, from a relatively great distance.

The high-reduction gear train is essential, as its use enables an infinitesimal angular movement of a controlled mobile inside the watch.

Indeed, documents EP4092494, CH718656, CH716962 filed by ETA Manufacture Horlogère Suisse describe near-field watch setting systems, and documents CH712578, CH716920, CH719089, EP4174584, CH713306 filed by Swatch Group Research and Development Ltd describe mechanisms for rate setting, for driving a control organ, or even for frequency regulation with no contact from outside the watch, these various systems making use of a magnetic field, but in direct drive, with no possibility of compensating for mechanical slack or of simple micrometric setting of such an internal controlled mobile.

The invention thus relates to a horology assembly 2000 comprising at least one watch 1000, and at least one setting tool 200, which is arranged to enable an internal mobile 1 comprised in each watch 1000 in this horology assembly 2000 to be driven, with no direct contact, through a case 10 on each watch 1000, so as to carry out a setting and/or an energy recharge. The internal control mobile 1 can be pivoted around a first axis D1.

Each setting tool 200 comprises means for generating an external magnetic field, rotating around an external axis DE, and which is arranged to engage in complementary attraction or repulsion with internal magnetic or ferromagnetic zones 11 comprised in the internal control mobile 1 in order to rotate this internal control mobile 1.

Each watch 1000 comprises an internal controlled mobile 2, which can be pivoted around a second axis D2 inside the case 10, and which is arranged to be driven by the internal control mobile 1. In the non-limiting embodiment illustrated by the figures, the internal control mobile 1 is pivoted between an upper bar 41 and a plate 42, and the internal controlled mobile 2 is also pivoted between the same upper bar 41 and plate 42, to optimally reduce the volume occupied by the kinematics for driving the internal controlled mobile 2 by the internal control mobile 1.

According to the invention, in each watch 1000, the internal control mobile 1 comprises a control pinion 13 meshing with an entry mobile 31 comprised in a reduction train 30 in which an exit mobile 32 meshes with the internal controlled mobile 2.

More specifically, and as can be seen in the figures, to keep its size to a minimum, the reduction train is very compact and comprises stepped wheels distributed around at least two separate axes of rotation referred to as transfer axes. In the particular, advantageous but non-limiting embodiment illustrated by the figures, the reduction train 30 comprises a first transfer axis D3 and a second transfer axis D4, two superpositions of stepped wheels each with the same diameter, respectively first stepped wheels 32, 35, 31 around the first transfer axis D3, and second stepped wheels 33, 34, around the second transfer axis D4. Advantageously, the first stepped wheels 32, 35, 31 and the second stepped wheels 33, 34 are all identical. Advantageously, in the non-limiting embodiment illustrated in the figures, the first stepped wheels 32, 35, 31 and the second stepped wheels 33, 34 are pivoted between the same upper bar 41 and plate 42, guiding the internal controlled mobile 2 and the internal control mobile 1. The reduction train 30 thus occupies an extremely small volume. Preferably, and with this arrangement, the reduction train 30 occupies a volume of less than 2% of the internal volume of the case 10.

Naturally, depending on the space available in the watchcase for turning in the reduction train, other arrangements can be used, such as pivoting some of its wheels around the first axis D1 or the second axis D2.

And, more specifically, the horology assembly 2000 comprises means for counting the number of turns of the external drive mobile 20 to precisely determine the pivot angle of said internal controlled mobile 2, and/or means for determining and/or for visualising the angular position of this internal controlled mobile 2. These counting means can also be means for measuring a duration, when, preferably, the external drive mobile 20 is pivoted at a constant velocity.

Indeed, the invention is applicable both to watches 1000 in which the internal controlled mobile 2 is visible, and to watches in which the internal controlled mobile 2 is not visible, concealed by other components of the movement or the watch.

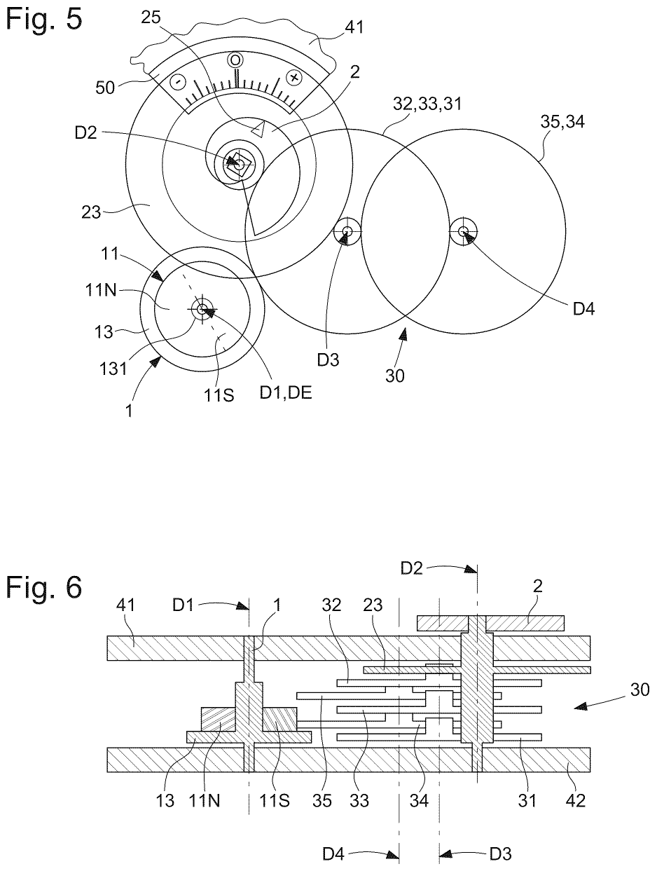

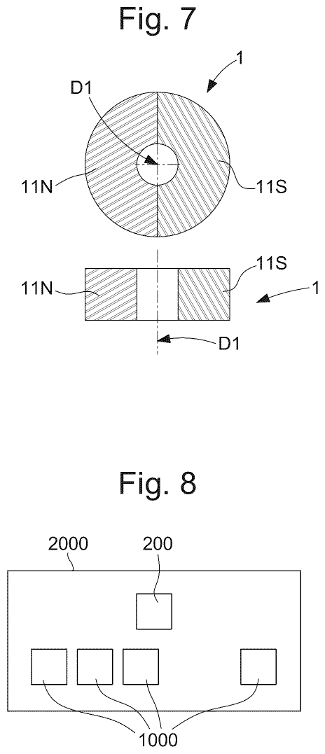

FIGS. 4 and 5 illustrate a variant in which the upper bar 41, acting as an upper guide for the internal control mobile 1, the internal controlled mobile 2 and the carrier arbors of the stepped wheels of the reduction train 30, comprises a graduated scale 50 for marking the angular position of an index 25 carried by the internal controlled mobile 2, in this case a snail cam.

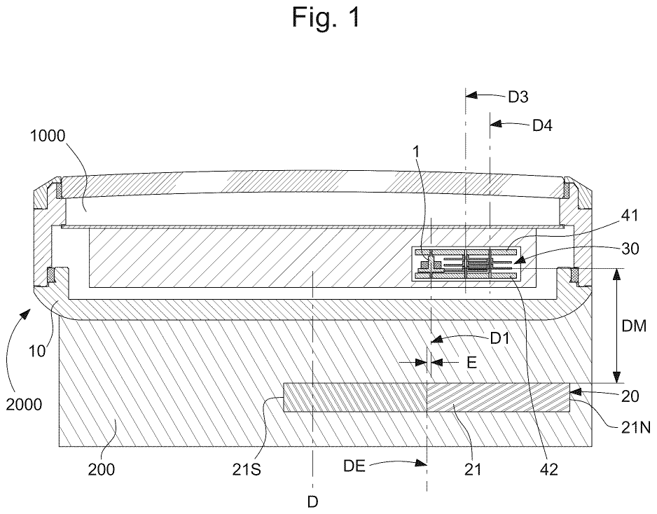

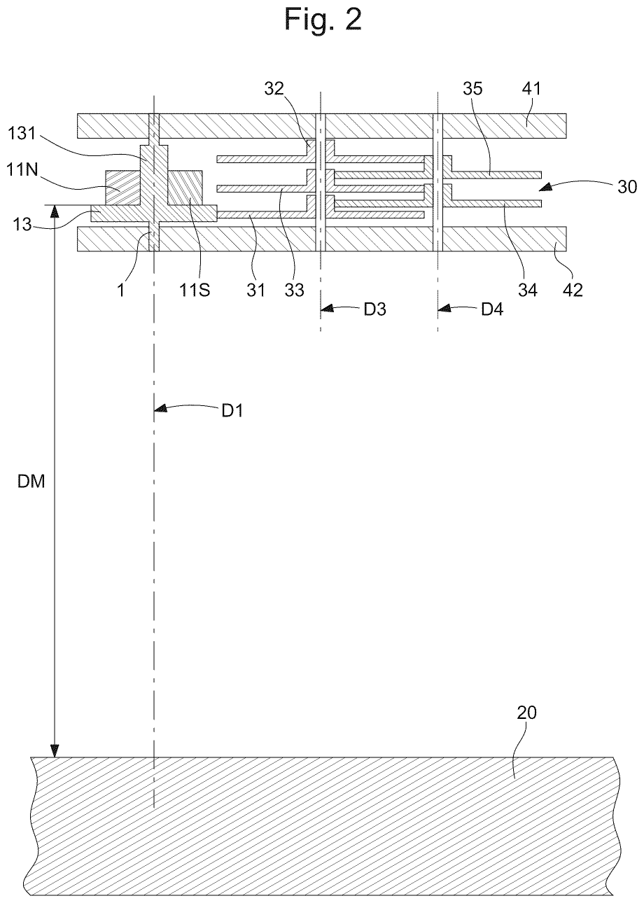

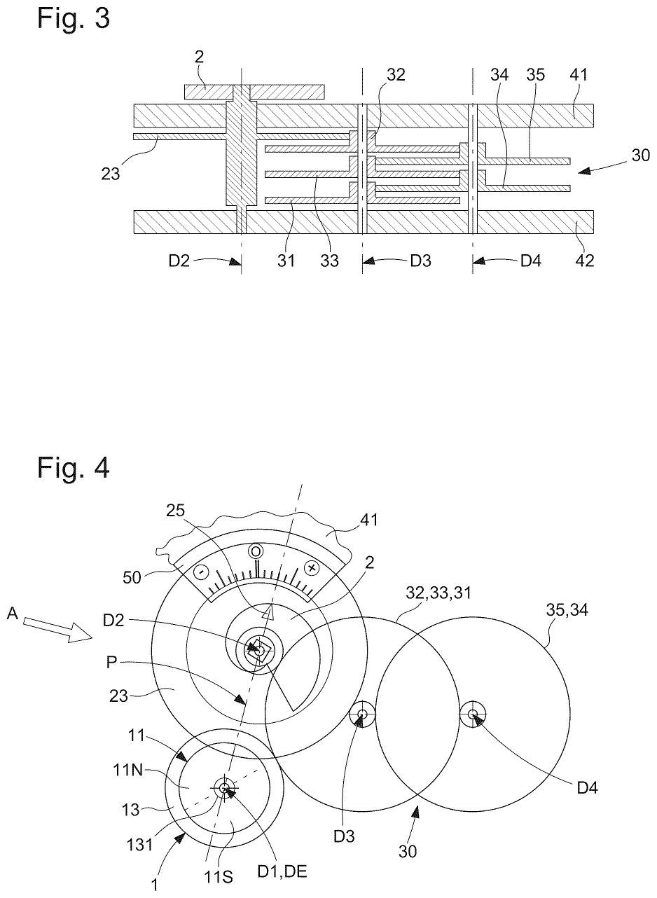

More specifically, the setting tool 200 comprises means for relative positioning with respect to the watchcase 10 for optimum positioning of the external axis DE parallel to the first axis D1 and with a centre distance E less than or equal to a predetermined value between the external axis DE and the first axis D1; more specifically and as can be seen in FIG. 1, the predetermined value is the value of the mechanical slack between the setting tool 200 and the case 10, and the external axis DE and the first axis D1 are then substantially aligned.

In a first embodiment illustrated by the figures, each setting tool 200 comprises means for pivoting an external drive mobile 20 external to the watch around an external axis DE.

More specifically, in this first embodiment, the means for generating a rotating external magnetic field comprise means for pivoting an external drive mobile 20 external to the watch around an external axis DE, and this external drive mobile 20 comprises at least one external multipolar magnet comprising external magnetic zones 21N; 21S with alternating polarities, arranged to engage in complementary attraction or repulsion with the internal magnetic 11 or ferromagnetic zones comprised in the internal control mobile 1 for rotating the internal control mobile 1.

Each setting tool 200 comprises external magnetic zones 21N, 21S, with alternating polarities, which are arranged to engage in a complementary manner with internal magnetic zones 11N, 11S, or with internal ferromagnetic zones, comprised in the internal control mobile 1, for driving the first internal mobile 1.

Preferably the drive mobile 20 comprises at least one external multipolar magnet, in particular a bipolar magnet, comprising such external magnetic zones 21N, 21S with alternating polarities.

More specifically, the setting tool 200 comprises means for axially positioning the external multipolar magnet at a predetermined distance relative to the case 10 so as to position it precisely relative to the internal control mobile 1 in the direction of the first axis D1. The relative positioning means between the watchcase 10 and the setting tool 200 thus define a magnetic distance DM between the nearest end surfaces of the external magnetic zones 21N, 21S, on one hand, and the internal magnetic zones 11S, 11N, on the other hand. It is, of course, advantageous for the magnetic distance DM to be as small as possible. It should nevertheless be noted that the invention offers the advantage of accommodating a magnetic distance DM of a few millimetres, which allows the internal control mobile to be driven through a thick back, or through an automatic train, or even through another mechanism inside the watch, and which also allows the internal control mobile to be driven from the top of the watch through the glass, and thereby allows the simultaneous installation on either side of the watch of two setting tools with different functions, for example one for setting the rate of the watch, and the other for setting the state of the watch.

The invention defines a law according to the parameters constituted by the value of the centre distance E, the magnetic distance DM, the nature and dimensions of the external magnetic zones, the nature and dimensions of the internal magnetic zones, and the architecture of the reduction train, which determines the value of the pivot angle of the internal controlled mobile 2 according to the number of turns imparted to the external drive mobile 20. The user has an abacus, or a computer programme, enabling the user to precisely determine the control to be used to achieve the desired setting.

In a second embodiment, not illustrated, the means for generating a rotating external magnetic field comprise means for supplying electrical power and distributing current to a plurality of even-numbered coils offset angularly around an external axis DE, for example and non-limitatively at 90° to each other, and arranged to generate a rotating electromagnetic field (similar to a brushless electric motor) capable of engaging in complementary attraction or repulsion, with the internal magnetic 11 or ferromagnetic zones comprised in the internal control mobile 1 for rotating the internal control mobile 1. For example, the coils are angularly equidistant, identical and sequentially powered in a single direction to generate the rotating field. In particular, a tool can be used to test the mechanical parts of a quartz watch, distributed by “Esslinger®” under the name “Horotec Watch Turbo Tester®” under part number MSA 19.107 or 64.107. Such a tool generates a field rotating at a few dozen turns per second.

It will be understood that the invention can be used in various applications, depending on the arrangement of the reduction train 30. A multiplier train can be suitable for winding functions, while a divisor train is particularly well-suited to setting functions, in particular micro-setting. This micro-setting function, which is usually carried out by a horologist, is always a delicate one, because simply closing the case can alter an accurate setting that has just been made. It is also very useful to have a means of micro-setting without opening the watchcase.

This latter alternative of a divisor train specifically for micro-setting functions is illustrated by the figures, in the particular and preferred case in which the reduction train 30 occupies a very small portion of the internal volume of the watch, particularly less than 5%, particularly less than or equal to 2%, with a very low mass as a proportion of the total mass of the watch, particularly less than 5%, particularly less than or equal to 2%. To achieve extremely precise micro-setting, the gear reduction factor is high, above 1,000, in particular above 10,000. These mass and space constraints naturally mean that the couple transmitted by the kinematic chain is severely limited, in particular to less than 30 milliNm. The choice of micro-manufacturing methods is essential for producing the wheels and pinions of the reduction train 30. Indeed, to ensure that the setting is impervious to any disruption from an external magnetic field, the reduction train 30 and the internal controlled mobile 2 are preferably made of non-magnetic material. Also, more specifically, the reduction train 30 comprises stepped wheels made of non-magnetic material, or stepped wheels made of silicon and/or of silicon oxide and/or of silicon carbide and/or of silicon nitride and/or of a nickel-phosphorus alloy (with an appropriate phosphorus content to remain non-magnetic, typically greater than or equal to 12%) and/or of an amorphous or partially amorphous non-magnetic metal alloy, or of a polymer, or the like.

More specifically, the means for pivoting the drive mobile 20 are arranged to drive this drive mobile 20 at an angular velocity greater than or equal to 10 turns per second, in particular greater than or equal to 40 turns per second.

More specifically, the internal control mobile 1 comprises at least one magnet, and in particular comprises at least one internal multipolar magnet with alternating polarities 11N, 11S, in particular bipolar, and comprising the internal magnetic zones.

More specifically, the internal control mobile 1 is or comprises a Lavet motor rotor.

More specifically, the reduction train 30 and the internal controlled mobile 2 are made of non-magnetic material.

More specifically, each watch 1000 comprises at least one means for keeping the internal control mobile 1 in position by applying an elastic mechanical positioning couple, and/or by applying a remaining magnetization, so as to immobilise the internal control mobile 1 in the absence of interaction from an external magnetic field. For example, a ferromagnetic pin near the rotor constituted by the internal control mobile 1 enables a positioning couple to be created for the rotor, which can be easily overcome in a setting phase by the application of the external rotating magnetic field.

More specifically, in one embodiment, not illustrated, the first axis D1 and the second axis D2 are aligned.

In a particular variant, not illustrated, the first internal mobile 1 is ferromagnetic. More specifically, the first internal ferromagnetic mobile 1 then has a particular form, which is designed to minimise the effects of attraction, of rotation or of repulsion of a uniform external magnetic field of typically 1.5 Tesla, and to minimise the rotation of the first internal mobile 1, in particular a ferromagnetic mobile, under the action of a uniform external magnetic field of typically 1.5 Tesla.

More specifically, the means for pivoting the drive mobile 20 are arranged to drive the drive mobile 20 at an angular velocity greater than or equal to 40 turns per second.

More specifically, the reduction train 30 produces a reduction factor greater than or equal to 10,000.

More specifically, the reduction train 30 produces a couple multiplication factor greater than 80,000.

It will be understood that a user or a repairer from outside the designer's network could manage to rotate the first internal mobile 1 with a single magnet of any size and strength, and can drive the reduction train and the second controlled mobile, but this outside manipulator is unaware of the law that forms the basis for the rotation of the controlled internal mobile, and cannot achieve the expected accurate setting.

More specifically, at least one watch 1000 in the horology assembly 2000 is a non-magnetic watch. Even more specifically, each watch 1000 in the horology assembly 2000 is a non-magnetic watch.

More specifically, at least one watch 1000 in the horology assembly 2000 is a mechanical watch. Even more specifically, each watch 1000 in the horology assembly 2000 is a mechanical watch.

More specifically, at least one watch 1000 in the horology assembly 2000 is an electromechanical or electronic watch. Even more specifically, each watch 1000 in the horology assembly 2000 is an electromechanical or electronic watch.

More specifically, the second internal mobile 2 is a control mobile for setting the rate of a regulating organ comprised in at least one watch 1000. The invention is particularly well-suited to setting the rate of a sprung balance by modifying the stiffness of said sprung balance.

More specifically, the second internal mobile 2 is a control mobile for setting the time of at least one watch 1000.

More specifically, the second internal mobile 2 is a control mobile for setting a calendar mechanism comprised in at least one watch 1000.

More specifically, the second internal mobile 2 is a control mobile for winding at least one watch 1000.

More specifically, the second internal mobile 2 is a mobile for controlling the setting of an alarm mechanism and/or a striking work comprised in at least one watch 1000.

More specifically, the internal controlled mobile 2 is a mobile for controlling the setting of a sensor calibration mechanism for an altimeter or depth gauge or compass function comprised in at least one watch 1000.

More specifically, the first internal mobile 1 is invisible to the user of at least one watch 1000.

More specifically, at least one watch 1000 has no external mechanical setting organ running through the casing of the watch 1000.

More specifically, at least one watch 1000 is water-resistant to gases and ambient humidity, and its casing comprises for this purpose at least one sealing zone suitable for undergoing a metallic or ceramic or glass sealing treatment in a vacuum or in a neutral gas atmosphere.

More specifically, at least one watch 1000 is sealed to be put under vacuum so as to be impervious to internal pressure variations caused by temperature variations.

More specifically, at least one watch 1000 is equipped with an RFID chip or a passive means of identification enabling the nature of the horology assembly 2000 to which the watch 1000 belongs, and of the setting tool 200 to be used, to be identified directly for after-sales purposes.

It is understood that the engagement between the case 10 and the setting tool 200, and the positioning of the first internal mobile 1, ensures that the system cannot be tampered with if a third party is unaware of the internal positioning of the internal control mobile 1 and, more importantly, of the law linking the drive of the external drive mobile 20 and the pivoting of the internal controlled mobile 2.

The invention also relates to a method for using such a 2000 horology assembly, enabling mechanical slack to be compensated before proceeding with the actual micrometric setting: in a first step, the internal control mobile 1 is exposed to an external rotating magnetic field with an intensity lower than a first predetermined threshold value, and for a duration shorter than a first predetermined duration, for a slack-compensating drive in the mechanical kinematic chain between the internal control mobile 1 and the internal controlled mobile 2, and in a second step, the internal control mobile 1 is exposed to an external rotating magnetic field with an intensity greater than a second predetermined threshold value, and for a duration greater than a second predetermined duration, for synchronous drive of the internal controlled mobile 2 by the internal control mobile 1 through said reduction train 30.

As a non-limiting example, the internal control mobile 1 and the internal controlled mobile 2 are pivoted between two bars less than 2 mm apart, between which five gears in the reduction train 30 are turned in, with two-gear Liga wheels with an external diameter of 3 mm, a gear ratio of 7 and a total reduction of 16,800. When projected in a plane in the direction of the first axis D1, the entire mechanism formed by the internal control mobile 1, the reduction train 30 and the internal controlled mobile 2 occupies a space of approximately 3 mm×6 mm. The internal control mobile 1 is a Lavet motor rotor with a diameter of 1.4 mm and a thickness of 0.5 mm. The external drive mobile 20 has a diameter of 20 mm and a thickness of 2 mm and comprises neodymium-iron-boron magnets. The couple exerted on the internal control mobile 1 by the external drive mobile 20 is 3 microNm, the portion of the couple devoted to positioning the rotor is 0.5 microNm, and the portion of the useful couple transmissible to the reduction train 30 is 2.5 microNm. At the exit of the reduction train 30, the useful couple for the internal controlled mobile 2, for example a snail cam as shown in FIG. 4, is 21 milliNm. In an application involving a rate setting, one turn of the internal controlled mobile 2 corresponds to a setting of 10 seconds. A setting of 0.1 seconds therefore corresponds to 168 turns of the internal control mobile 1. If the motor driving the external drive mobile 20 turns at 50 turns per second, it takes 40 seconds to very accurately set 1 second on the internal controlled mobile 2. The system volume in this case accounts for only 1% to 2% of the calibre volume.

The effective size of the system must remain small relative to the main features inside the watch.

The mechanism according to the invention should only be handled in the works, or at a specialist shop, or by an after-sales service authorised by the designer, to avoid any unintentional disruption by the customer or third parties.

This system can fully replace conventional buttons and stems, making it possible to produce automatic or other watches that are much more water-resistant than the current ones.

1. A horology assembly (2000) comprising at least one watch (1000) and at least one setting tool (200) arranged to enable the drive, with no direct contact, of an internal control mobile (1), which is pivotally mobile around a first axis (D1), comprised in each said watch (1000) in said horology assembly (2000), through a case (10) comprised in each said watch (1000), for carrying out a setting and/or an energy recharge, each said setting tool (200) comprising means for generating an external magnetic field rotating around an external axis (DE) and arranged to engage in complementary attraction or repulsion with internal magnetic or ferromagnetic zones (11) comprised in said internal control mobile (1) to rotate said internal control mobile (1), each said watch (1000) comprising an internal controlled mobile (2) pivotally mobile around a second axis (D2) inside said case (10), characterised in that, in each said watch (1000), said internal control mobile (1) comprises a control pinion (13) meshing with an entry mobile (31) comprised in a reduction train (30), in which an exit mobile (32) meshes with said internal controlled mobile (2).

2. The horology assembly (2000) according to claim 1, characterised in that said reduction train (30) comprises at least a first transfer axis (D3) carrying first stepped wheels (32, 35, 31), and a second transfer axis (D4) carrying second stepped wheels (33, 34).

3. The horology assembly (2000) according to claim 1, characterised in that said horology assembly (2000) comprises means for counting the number of turns of said external magnetic field to precisely determine the pivot angle of said internal controlled mobile (2), and/or means for determining and/or visualising the angular position of said internal controlled mobile (2).

4. The horology assembly (2000) according to claim 3, characterised in that an upper bar (41), acting as an upper guide for said internal control mobile (1), said internal controlled mobile (2), and for arbors carrying stepped wheels (32, 35, 31, 33, 34) comprised in said reduction train (30), comprises a graduated scale (50) for locating the angular position of an index (25) carried by said internal controlled mobile (2).

5. The horology assembly (2000) according to claim 1, characterised in that said setting tool (200) comprises positioning means relative to said case (10) for positioning said external axis (DE) parallel to said first axis (D1) and with a centre distance (E) less than or equal to a predetermined value between said external axis (DE) and said first axis (D1).

6. The horology assembly (2000) according to claim 1, characterised in that said means for generating a rotating external magnetic field comprise means for pivoting an external drive mobile (20) external to the watch around an external axis (DE), said external drive mobile (20) comprising at least one external multipolar magnet comprising external magnetic zones (21N; 21S) with alternating polarities, arranged to engage in complementary attraction or repulsion with said internal magnetic (11) or ferromagnetic zones comprised in said internal control mobile (1) for rotating said internal control mobile (1).

7. The horology assembly (2000) according to claim 1, characterised in that said means for generating a rotating external magnetic field comprise means for supplying electrical power and distributing current to a plurality of coils offset angularly around an external axis (DE), and arranged to generate a rotating electromagnetic field capable of engaging in complementary attraction or repulsion, with said internal magnetic (11) or ferromagnetic zones comprised in said internal control mobile (1) for rotating said internal control mobile (1).

8. The horology assembly (2000) according to claim 1, characterised in that said setting tool (200) comprises means for axially positioning a reference plane of said external magnetic field rotating at a predetermined distance (DM) relative to said case (10) to position it precisely relative to said internal control mobile (1) in the direction of said first axis (D1).

9. The horology assembly (2000) according to claim 6, characterised in that said setting tool (200) comprises means for axially positioning said at least one external multipolar magnet rotating at a predetermined distance (DM) relative to said case (10) to position it precisely relative to said internal control mobile (1) in the direction of said first axis (D1).

10. The horology assembly (2000) according to claim 1, characterised in that said reduction train (30) occupies a volume of less than 2% of the internal volume of said case (10).

11. The horology assembly (2000) according to claim 1, characterised in that said reduction train (30) comprises stepped wheels (32, 35, 31, 33, 34) made of non-magnetic material, or stepped wheels (32, 35, 31, 33, 34) made of silicon and/or of silicon oxide and/or of silicon carbide and/or of polymer.

12. The horology assembly (2000) according to claim 1, characterised in that said reduction train (30) comprises stepped wheels (32, 35, 31, 33, 34) that are all identical.

13. The horology assembly (2000) according to claim 1, characterised in that said means for pivoting said drive mobile (20) are arranged to drive said drive mobile (20) at an angular velocity greater than or equal to 40 revolutions per second.

14. The horology assembly (2000) according to claim 1, characterised in that said reduction train (30) produces a reduction factor greater than or equal to 10,000.

15. The horology assembly (2000) according to claim 1, characterised in that said reduction train (30) produces a couple multiplication factor greater than 80,000.

16. The horology assembly (2000) according to claim 1, characterised in that said internal control mobile (1) comprises at least one internal multipolar magnet with alternating polarities (11N; 11S) comprising said internal magnetic zones (11), or in that said internal control mobile (1) is or comprises a Lavet motor rotor.

17. The horology assembly (2000) according to claim 1, characterised in that said reduction train (30) and said internal controlled mobile (2) are made of non-magnetic material.

18. The horology assembly (2000) according to claim 1, characterised in that each said watch (1000) comprises at least one means for keeping said internal control mobile (1) in position by applying an elastic mechanical positioning couple and/or by applying a remaining magnetization, so as to immobilise said internal control mobile (1) in the absence of interaction from an external magnetic field.

19. The horology assembly (2000) according to claim 1, characterised in that said internal controlled mobile (2) is a mobile for controlling the rate setting of a regulating organ comprised in at least one said watch (1000), or is a mobile for controlling the state setting of at least one said watch (1000).

20. The horology assembly (2000) according to claim 1, characterised in that at least one said watch (1000) is equipped with an RFID chip or with a passive identification means enabling direct after-sale identification of the nature of said horology assembly (2000) to which said watch (1000) belongs, and of said setting tool (200) to be used for adjusting said watch (1000).

21. A method for using a horology assembly (2000) according to claim 1, characterised in that, in a first step, said internal control mobile (1) is exposed to an external rotating magnetic field with an intensity lower than a first predetermined threshold value, and for a duration shorter than a first predetermined duration, for a slack-compensating drive in the mechanical kinematic chain between said internal control mobile (1) and said internal controlled mobile (2), and in that, in a second step, said internal control mobile (1) is exposed to an external rotating magnetic field with an intensity greater than a second predetermined threshold value, and for a duration greater than a second predetermined duration, for synchronous drive of said internal controlled mobile (2) by said internal control mobile (1) through said reduction train (30).

22. A watch (1000) comprising a case (10) containing an internal control mobile (1) that pivots around a first axis (D1) and an internal controlled mobile (2) that pivots around a second axis (D2), characterised in that, in each said watch (1000), said internal control mobile (1) comprises a control pinion (13) meshing with an entry mobile (31) comprised in a reduction train (30) in which an exit mobile (32) meshes with said internal controlled mobile (2).

23. The watch (1000) according to claim 22, characterised in that said reduction train (30) comprises at least a first transfer axis (D3) carrying first stepped wheels (32, 35, 31), and a second transfer axis (D4) carrying second stepped wheels (33, 34).

24. The watch (1000) according to claim 23, characterised in that an upper bar (41), acting as an upper guide for said internal control mobile (1), said internal controlled mobile (2), and for arbors carrying stepped wheels (32, 35, 31, 33, 34) comprised in said reduction train (30), comprises a graduated scale (50) for locating the angular position of an index (25) carried by said internal controlled mobile (2).

25. The watch (1000) according to claim 22, characterised in that said reduction train (30) occupies a volume of less than 2% of the internal volume of said case (10).

26. The watch (1000) according to claim 22, characterised in that said reduction train (30) comprises stepped wheels (32, 35, 31, 33, 34) made of non-magnetic material, or stepped wheels (32, 35, 31, 33, 34) made of silicon and/or of silicon oxide and/or of silicon carbide and/or of polymer.

27. The watch (1000) according to claim 22, characterised in that said reduction train (30) comprises stepped wheels (32, 35, 31, 33, 34) that are all identical.

28. The watch (1000) according to claim 22, characterised in that said reduction train (30) produces a reduction factor greater than or equal to 10,000.

29. The watch (1000) according to claim 22, characterised in that said reduction train (30) produces a couple multiplication factor greater than 80,000.

30. The watch (1000) according to claim 22, characterised in that said internal control mobile (1) comprises at least one internal multipolar magnet with alternating polarities (11N; 11S) comprising said internal magnetic zones (11), or in that said internal control mobile (1) is or comprises a Lavet motor rotor.

31. The watch (1000) according to claim 22, characterised in that said reduction train (30) and said internal controlled mobile (2) are made of non-magnetic material.

32. The watch (1000) according to claim 22, characterised in that each said watch (1000) comprises at least one means for keeping said internal control mobile (1) in position by applying an elastic mechanical positioning couple and/or by applying a remaining magnetization, so as to immobilise said internal control mobile (1) in the absence of interaction from an external magnetic field.

33. The watch (1000) according to claim 22, characterised in that said internal controlled mobile (2) is a mobile for controlling the rate setting of a regulating organ comprised in at least one said watch (1000), or is a mobile for controlling the state setting of at least one said watch (1000).

34. The watch (1000) according to claim 22, characterised in that at least one said watch (1000) is equipped with an RFID chip or with a passive identification means enabling direct after-sale identification of the nature of said horology assembly (2000) to which said watch (1000) belongs, and of said setting tool (200) to be used for adjusting said watch (1000).
